(19) United States
(12) Patent Application Publication
(10) Pub. No.: US 2017/0143137 A1
(43) Pub. Date: May 25, 2017

(54) RETAIL SALES DISPLAY

(71) Applicant: JAB Distributors, LLC, Wheeling, IL (US)

(72) Inventor: Warrick Bell, Northbrook, IL (US)

(21) Appl. No.: 15/356,119

(22) Filed: Nov. 18, 2016

Related U.S. Application Data
(60) Provisional application No. 62/258,198, filed on Nov. 20, 2015.

(51) Int. Cl. A47F 7/30; A47F 5/00; G09F 5/00; A47C 19/02

(52) U.S. Cl. CPC A47F 7/30; A47C 19/025; A47F 5/0018; A47F 5/0062; G09F 5/00

(57) ABSTRACT

A retail sales display rack for presentation of three separate mattress sections. Each mattress section has thickness to provide a different cushioning feel to the customer so as to represent different mattresses for sale. The rack positions the three mattress sections such that the top surface of each mattress section is located in a single horizontal plane and allows the customer to occupy a prone position on the top surface of one of the mattress sections and roll onto another of the mattress sections.

### CLAIM OF PRIORITY

This patent application claims benefit from U.S. Provisional Patent Application Ser. No. 62/258,198, filed on Nov. 20, 2015. The above stated application is hereby incorporated herein by reference in its entirety.

### BACKGROUND

The invention relates to a retail sales display and more particularly to a mattress sales display.

Typically, actual sized mattresses are presented on a sales floor for viewing by customers. The mattresses are arranged on a box spring unit, or at times, laying flat on the floor. The customer tests the feel of several mattresses by resting in a prone position on one mattress, and then moving to another mattress for resting in a prone position. The process of standing up and moving from one mattress to another mattress makes it difficult for the customer to distinctly remember the comfort and response of each mattress to make a comparison. The customer also obtains a visual view of the mattress in terms of its size, particularly its height or thickness.

A mattress manufacturer will often produce products with only minor internal changes, such as a variant in the spring compression to change the overall firmness of the mattress, creating a product very similar in outward appearance and construction. Typically, queen size mattresses are presented for display on a showroom floor. To display the entire product line would require a large area to provide sufficient room for a number of mattresses. To minimize the space required to display outwardly similar mattresses with only internal changes, it is within the prior art for a mattress manufacturer to provide a showroom mattress where the mattress is internally divided longitudinally and constructed with one internal variant on one side and a second internal variant on the other.

Mattress manufacturers are embracing alternative construction materials, such as memory foam and cooling gels, as well as traditional materials, such as spring construction, to produce more advanced bedding. It is common for mattresses to be differentiated by adding layered sections of these materials which produce mattresses having significant and outwardly visible variations in thickness.

It is therefore an object of the present invention to provide a sales display for use in the retail sales of mattresses.

It is a further object of the present invention to provide a mattress display which occupies a small amount of display area.

It is a further object of the present invention to provide a quick and easy way for a customer to compare the differences in a number of mattresses.

### BRIEF SUMMARY

These and other objects are achieved in a mattress display which presents a single bed unit formed of a plurality of separate and different mattress sections (e.g., three different mattress sections). A mattress to be sold may be represented by a corresponding mattress section, which may have a different height from each of the other mattress sections, to allow for visual appearance as well as cushioning construction of the corresponding mattress. A display rack may position the plurality of mattress sections in a side-by-side arrangement such that the top surfaces of each of the mattress sections are disposed in a horizontal plane.

### BRIEF DESCRIPTION OF SEVERAL VIEWS OF THE DRAWINGS

FIG. 1 is a front perspective view of a retail sales display for mattresses.

FIG. 2 is a side perspective view of the retail sales display of FIG. 1.

FIG. 3 is a perspective view of a supporting unit of the retail sales display of FIG. 1.

FIG. 4 is a perspective view of another embodiment of the retail sales display of FIG. 1.

FIG. 5 is a perspective view of a platform spacer.

### DETAILED DESCRIPTION

The following discussion presents various aspects of the present disclosure by way of one or more examples. Such examples are non-limiting, and thus the scope of various aspects of the present disclosure should not necessarily be limited by any particular characteristics of the provided examples. In the following discussion, the phrases “for example,” “e.g.,” and “exemplary” are non-limiting and are generally synonymous with “by way of example and not limitation,” “for example and not limitation,” and the like.

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.”

The terminology used herein is for the purpose of describing particular examples only and is not intended to be limiting of the disclosure. As used herein, the singular forms are intended to include the plural forms as well, unless the context clearly indicates otherwise. It will be further understood that the terms “comprises,” “includes,” “comprising,” “including,” “has,” “have,” “having,” and the like when used in this specification, specify the presence of stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present disclosure. Similarly, various spatial terms, such as “upper,” “lower,” “side,” and the like, may be used in distinguishing one element from another element in a relative manner. It should be understood, however, that components may be oriented in different manners, for example a component may be turned sideways so that its “top” surface is facing horizontally and its “side” surface is facing vertically, without departing from the teachings of the present disclosure.

In the drawings, various dimensions (e.g., layer thickness, width, etc.) may be exaggerated for illustrative clarity. Additionally, like reference numbers are utilized to refer to like elements through the discussions of various examples.

The discussion will now refer to various example illustrations provided to enhance the understanding of the various aspects of the present disclosure. It should be understood that the scope of this disclosure is not limited by the specific characteristics of the examples provided and discussed herein.

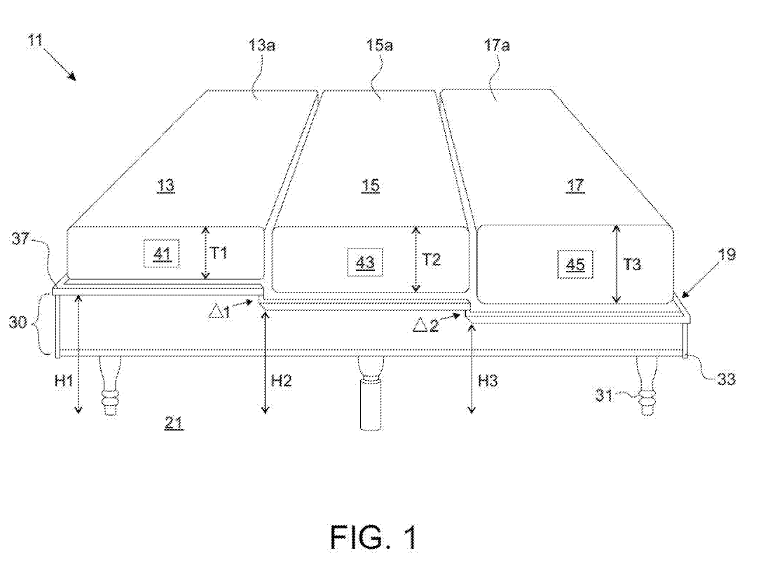

Referring to FIGS. 1-3, a retail sales display 11 may include a plurality of mattress sections 13, 15, 17 and a display rack or support structure 19. The display rack 19 may comprise a base 30 supported above a floor by a plurality of legs 31. As explained in more detail below, the base 30 may comprise a plurality of supports surfaces 25, 27, 29 upon which respective mattress sections 13, 15, 17 may rest and a plurality of vertical, side walls 35 that raise the plurality of support surfaces 25, 27, 29 at different heights above a bottom 33 of the base 30.

As shown, each mattress section 13, 15, 17 may comprise a separate unit that includes its own mattress casing, springs, filling material, and/or other support cushioning, which cooperate to support a person lying upon a top surface 13a, 15a, 17a of the mattress section 13, 15, 17. Alternatively, the mattress section 13, 15, 17 may be constructed as a single unit or joined together by stitching, adhesives, or other means of mechanical fastening.

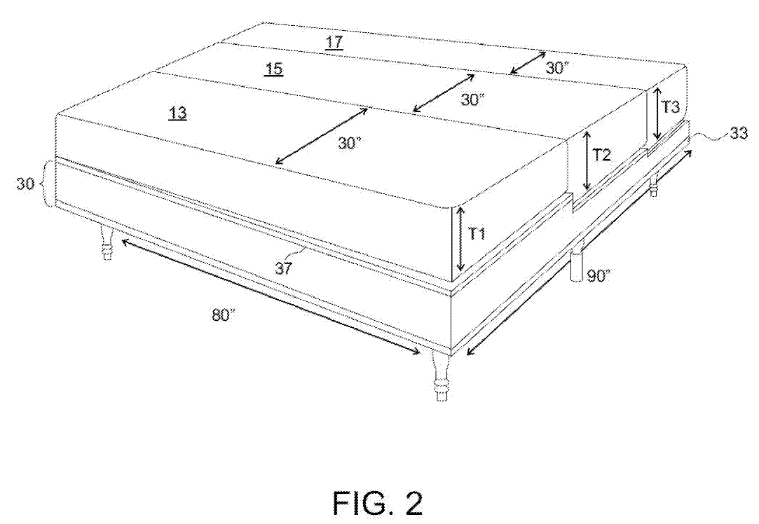

As indicated in FIG. 2, each of the mattress sections 13, 15, 17 may have an equal width (e.g. thirty (30) inches) and an equal length (e.g., eighty (80) inches). While each mattress section 13, 15, 17 may have the same length and width, each mattress section 13, 15, 17 may have a different height or thickness. For example, the first mattress section 13 may have a first thickness T1 (e.g., eight inches), the second mattress section 15 may have a second thickness T2 (e.g., ten inches), and the third mattress section 17 may have a third thickness (e.g., twelve inches).

Despite different thicknesses T1, T2, T3, the display unit 19 may support mattress sections 13, 15, 17 in a side-by-side arrangement in which their top surfaces 13a, 15a and 17a are disposed at the same height above a display room floor 21 as shown in FIGS. 1 and 2. As such, a customer may lay in a prone sleeping position on the top surface of mattress section 13 to obtain a “feel” for an actual mattress (not shown) corresponding to mattress section 13. Such a mattress corresponding to section 13 may be for sale in conventional mattress sizes (e.g., regular, queen, king, etc.). Thereafter, the customer may roll from mattress section 13 onto mattress section 15 to obtain a feel for a different mattress (not shown) corresponding to mattress section 15. Then, the customer may roll over onto mattress section 17 to obtain a feel of a different mattress (not shown) corresponding to mattress section 17.

The construction of the actual mattresses may be of a similar construction as the corresponding sections 13, 15, 17. As such, the actual mattresses may have different heights (or thicknesses), which provide a different comfort level or quality of feel to the sleeper. The mattress sections 13, 15, 17 likewise provide a corresponding different comfort level of quality of feel to the customer, thus permitting the customer to quickly compare the difference in feel between the actual mattresses using the mattress sections 13, 15, 17 as surrogates.

In addition, each mattress section may include visual indicia 41, 43, 45, which may be located at a respective end of each mattress section 13, 15, 17. The visual indicia 41, 43, 45 may include text, symbols, graphics, etc. printed on the casings of the mattress sections 13, 15, 17 themselves or attached to the ends of the mattress sections 13, 15, 17 via labels, stickers, tags, etc, which identify to the customer the particular mattress that corresponds to a respective section 13, 15, 17. In addition, the visual indicia 41, 43, 45 may also include a transparent window allowing the customer to view the internal construction of the mattress section.

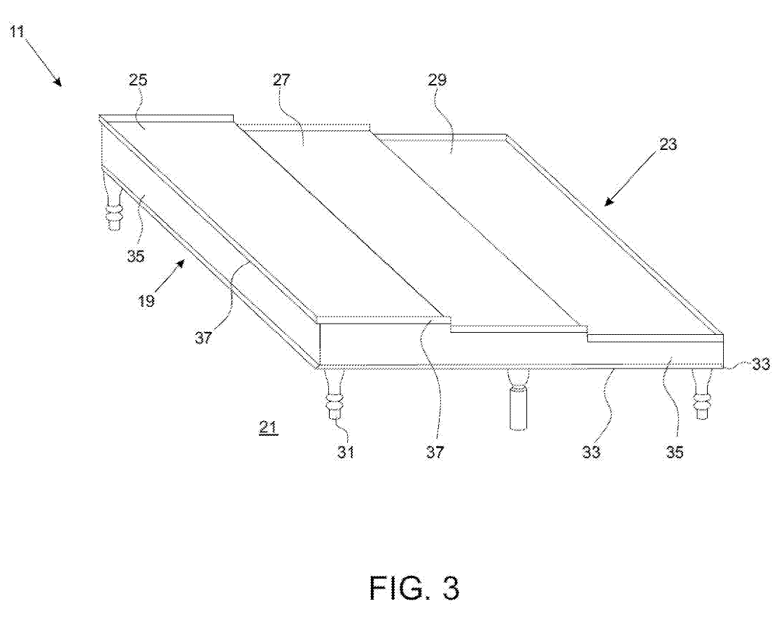

Referring to FIG. 3, the display rack 19 may include a top portion 23 comprising a plurality of support surfaces 25, 27, 29. Each support surface 25, 27, 29 may be disposed in a separate, horizontal plane relative to the floor 21. Each support surface 25, 27, 29 may provide a unitary and flat surface for mating with a flat, bottom surface of each mattress section 13, 15, 17. The support surfaces 25, 27, 29 may take on configurations other than a unitary, flat surface. For example, the support surfaces 25, 27, 29 may include openings or apertures passing through the support surface 25, 27, 29 toward the floor and/or may be formed from multiple support members, which collectively form a suitable horizontal surface to support the flat, bottom surface of the respective mattress sections 13, 15, 17.

As shown, the base 30 may dispose the first support surface 25 at a first height H1 relative to floor 21. The base 30 may dispose the second support surface 27 at a second height H2 relative to floor 21, where the second height H2 differs from the first height H1. The base 30 may also dispose the third support surface 29 at a third height H3 relative to floor 21, where the third height H3 differs from the first height H1 and the second height H2. The difference in heights H1, H2, H3 of the support surfaces 25, 27, 29 serves to position mattress sections 13, 15, 17 so that their respective top surfaces 13a, 15a, and 17a are located in the same horizontal plane and are thus coplanar. In particular, the difference Δ1 between heights H1, H2 of the first and second support surfaces 25, 27 may be the same as the difference in thicknesses T1, T2 between the first and second mattress sections 13, 15. Similarly, the difference Δ2 between heights H2, H3 of the second and third support surfaces 27, 29 may be the same as the difference in thicknesses T2, T3 between the second and third mattress sections 15, 17.

For example, in one embodiment, the second height H2 of the second support surface 27 may be two inches less than the first height H1 of the first support surface 25 to accommodate for a second mattress section 15 that is two inches thicker than the first mattress section 13. Similarly, the third height H3 of the third support surface 29 may be two inches less than the second height H2 to accommodate for a third mattress section 17 that is two inches thicker than the second mattress section 15. Thus, despite the differences in thickness of the mattress sections 13, 15, 17, the support surfaces 25, 27, 29 may accommodate for such thicknesses and position the mattress sections 13, 15, 17 such that the top surfaces 13a, 15a, 17a of the mattress sections 13, 15, 17 substantially align along a common, horizontal plane.

A plurality of legs 31 may be secured to the bottom 33 of the display rack 19. The number of legs 31 may be, for example, six or more, so as to maintain display rack 19 and mattress sections 13, 15, 17 in a sturdy position when the customer lays and rolls onto and across the top surfaces 13a, 15a, 17a of mattress sections 13, 15, 17. The bottom 33 may provide a unitary, flat, planar surface to which legs 31 may be secured. In other embodiments, the bottom 33 may provide an outline or frame structure about the mattress sections 13, 15, 17 or may take on other configurations as will suggest themselves.

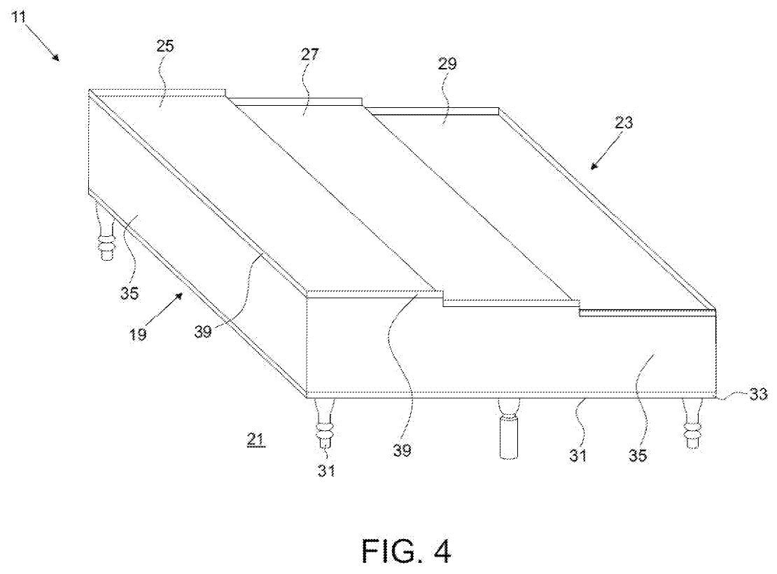

As shown in FIG. 3, the display rack 19 may include four side walls 35 of a size to visually appear as a box spring unit. The display rack 19 may further includes a plurality of rails 37 that protrude horizontally, outward beyond side walls 35. The plurality of rails 37 may be located at various positions along edges of support surfaces 25, 27 29 to provide such support surfaces 25, 27, 29 with raised edges. As such, the rails 37 may effectively extend the support surfaces 25, 27, 29 beyond the side walls 35. The rails 37 may help guide retail store personnel in their placement of mattress sections 13, 15, 17 onto support surfaces 25, 27, 29. Furthermore, the rails 37 may extend vertically, upwardly from edges of support surfaces 25, 27, 29 to prevent horizontal movement of the mattress sections 13, 15, 17 relative to support surfaces 25, 27, 29. The rails 37 may form an outside perimeter around the edge of the four side walls 35 as shown in FIG. 3 and FIG. 4 or may form a perimeter around the edge of the support surfaces 25, 27, 29.

FIG. 4 shows another embodiment of a display rack 19′. The display rack 19′ may be implemented in a manner similar to the display rack 19 of FIG. 3. The display rack 19′, however, includes flush rails 39 instead of protruding rails 37. The rails 39 may be raised vertically, upward from support surfaces 25, 27, 29 in a manner similar to rails 37. However, the rails 39 are flush with side walls 35 and, unlike raised rails 37, do not horizontally extend or protrude beyond the vertical surfaces of side walls 35. As such, the flush rails 39 and side walls 35, in some embodiments, may be integrally formed.

The display rack 19 shown in FIGS. 1-4 illustrates a three-platform design with a mattress sections 13, 15, 17 of 30 inches as indicated in FIG. 2.; however, the number of platforms and width is non-limiting for this disclosure. A display rack 19 comprising a similar two-platform construction for accepting of mattress section 13, 15 has additional commercial benefits.

A two-platform display rack 19 with 30 inch mattress sections 13, 15 similar to the construction illustrated in FIG. 2. produces an overall display rack 19 with a width of 60 inches which conforms to the standard dimensions of a queen sized bed which is common in a mattress show room. Such an embodiment has the desirable effect of being able to use commonly available bedding materials such as sheets, covers, and pillows.

The mattress section 13, 15, 17 with a width of 30 inches as indicated in FIG. 2 is a reasonable width for consumers trials based on frontal body plane cross-section; however, it is a non-standard mattress size and requires a manufacturer to produce units specifically for showroom purposes. A two-platform display rack 19 accepting of mattress section 13, 15 with a width of 38 inches allows for standard twin-sized mattress sections reducing the burden of custom mattresses.

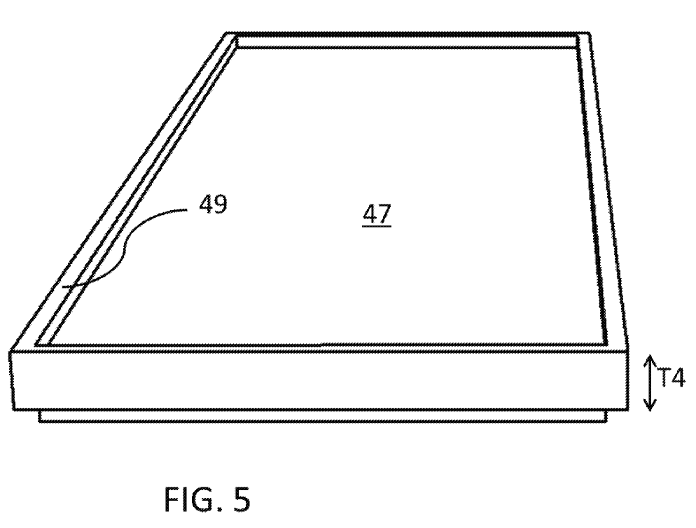

A platform spacer 47 to provide further adjustment in the height is shown in FIG. 5. The platform spacer 47 interacts with display rack 19 by resting upon the support surfaces 25, 27, 29 and engaging within the perimeter created by the rails 37 of the display rack 19. The platform spacer 47 may also have a set of upper rails 49 forming a perimeter around the top surface of the platform spacer for purposes of aligning the mattress sections 13, 15. The thickness T4 of the platform spacer 47 may include at a number of nominal values, such as 1 inch, 1.5 inches, 2 inch, etc., so that a single platform spacer 47 may raise a single mattress section 13, 15, 17 an appropriate amount to create the desired coplanar top surfaces. Any number of platform spacers 47 may be vertically stacked between the mattress display 19 support platform 25, 27, 29 and the mattress section 13, 15, 17 to produce a co-coplanar surface.

While the invention has been particularly shown and described with reference to preferred embodiments thereof, it will be understood by those skilled in the art that various modifications in form and detail may be made therein without departing from the scope and spirit of the invention. Accordingly, modifications such as those suggested above, but not limited thereto are to be considered within the scope of the invention.

Through the embodiments disclosed herein, specifically the display rack 19, mattress sections 13, 15, 17 of various heights, and platform spacer 47, a showroom may create a custom bedding display which allows customers to make a comparison with increased perception by resting upon multiple mattresses at a coplanar surface without leaving a horizontal position.

What is claimed is:

1. A mattress display for retail sale presentation at a location on a showroom floor, the mattress display comprising:
a plurality of mattress sections, each mattress section comprising a bottom surface and a top surface separated from the bottom surface by a mattress thickness that differs from thicknesses of other mattress sections of the plurality of mattress sections; and
a display rack comprising a plurality of support surfaces, each support surface positioned at a height that results in each support surface supporting, in side-by-side arrangement, the bottom surface of a respective mattress section such that top surfaces of the plurality of mattress sections are coplanar.

2. The mattress display of claim 1, wherein the plurality of mattress sections visually present a single mattress unit.

3. The mattress display of claim 1, wherein each mattress section provides a different comfort level.

4. The mattress display of claim 1, wherein each mattress section provides a similar comfort level as a corresponding mattress for sale.

5. The mattress display of claim 1, wherein said display rack includes a plurality of legs, each leg connected to a bottom of the display rack and a configured to support the bottom of the display rack above the showroom floor.

6. The mattress display of claim 1, wherein:
the plurality of mattress sections comprises a first mattress section, a second mattress section, and a third mattress section; and
wherein the plurality of support surfaces comprises a first support surface positioned to support the first mattress section, a second support surface positioned to support the second mattress section, and a third support surface positioned to support the third mattress section.

7. The mattress display of claim 6, wherein each support surface of the plurality of supports surfaces provides a flat, planar surface.

8. The mattress display of claim 6, wherein each support surface of the plurality of support surfaces is disposed in a different horizontal plane than the other support surfaces of the plurality of support surfaces.

9. The mattress display of claim 1, comprising one or more rails that provide a raised edge along the plurality of support surfaces

10. A display rack for presenting first, second, and third mattress sections respectively having different first, second, and third thicknesses such that top surfaces of the first, second, and third mattress sections are coplanar, the display rack, comprising:
a bottom;
first, second, and third support surfaces configured to respectively support the first, second, and third mattress sections in a side-by-side arrangement;
a plurality of side walls between the bottom and the first, second, and third support surfaces;
wherein the first support surface is disposed at a first height above the bottom;
wherein the second support surface is disposed at a second height above the bottom that is based upon a difference in thickness between the first mattress section and the second mattress section;
wherein the third support surface is disposed at a third height above the bottom that is based upon a difference in thickness between the second mattress section and the third mattress section.

11. The display rack of claim 10, wherein the second height is two inches closer to the bottom than the first height to accommodate the second mattress section being two inches thicker than the first mattress section.

12. The display rack of claim 11, wherein the third height is two inches closer to the bottom than the second height to accommodate the third mattress section being two inches thicker than the second mattress section.

13. The display rack of claim 10, wherein the first, second, and third support surfaces are configured to visually present the first, second, and third mattress sections visually as a single mattress unit.

14. The display rack of claim 10, further comprising a plurality of legs, each leg connected to the bottom of the display rack and a configured to support the bottom of the display rack above a floor.

15. The display rack of claim 10, wherein each of the first, second, and third support surfaces provides a flat, planar surface.

16. The display rack of claim 10, further comprising one or more rails that provide a raised edge along the first, second, and third support surfaces.

17. The display rack of claim 10, further comprising rail that provides a raised edge along an edge of the first support surface.

18. The display rack of claim 10, further comprising rail that provides a raised edge along an edge of the first support surface that extends outwardly beyond a side wall of the plurality of side walls.

19. The display rack of claim 10, further comprising rail that provides a raised edge along an edge of the first support surface that is flush with a side wall of the plurality of side walls.

20. The display rack of claim 10, further comprising rail that provides a raised edge along an edge of the first support surface that is flush and integral with a side wall of the plurality of side walls.
